(19) United States
(12) Patent Application Publication
(10) Pub. No.: US 2019/0317825 A1
(43) Pub. Date: Oct. 17, 2019

(54) SYSTEM FOR MANAGING DEPLOYMENT OF DISTRIBUTED COMPUTING RESOURCES

(71) Applicant: KAZUHM, INC., San Diego, CA (US)

(72) Inventors: Tim O'NEAL, Carlsbad, CA (US); Konstantin BOGATYREV, San Diego, CA (US)

(21) Appl. No.: 16/146,223

(22) Filed: Sep. 28, 2018

Related U.S. Application Data
(60) Provisional application No. 62/658,521, filed on Apr. 16, 2018.

(51) Int. Cl. G06F 9/50; H04L 29/08; G06F 8/61; G06F 9/54; G06F 9/455

(52) U.S. Cl. CPC G06F 9/5077; G06F 9/5072; G06F 9/5044; G06F 2009/45562; G06F 8/61; G06F 9/546; G06F 9/45558; H04L 67/34

(57) ABSTRACT

Certain aspects of the present disclosure provide methods and systems for managing deployment of distributed computing resources, including: causing a node agent to be installed on a remote computing node, wherein the node agent is configured to run as an application with user-level privileges on the remote computing node; transmitting, to the node agent using a compact messaging protocol, a request to install a container on the remote computing node, wherein the container is pre-configured with an application; transmitting, to the node agent using the compact messaging protocol, a request to run the application in the container on the remote computing node; and receiving, from the application running on the remote computing node, application data.

### CROSS-REFERENCE TO RELATED APPLICATIONS

This application claims priority to U.S. Provisional Patent Application No. 62/658,521, filed on Apr. 16, 2018, which is incorporated herein by reference in its entirety.

### INTRODUCTION

Aspects of the present disclosure relate to systems and methods for managing deployment of distributed computing resources.

Computing is increasingly ubiquitous in modern life. Whether it is a smartphone, smart appliance, self-driving car, or some other application, the amount of active computing devices, and therefore available computing resources, is beyond measure. The demand for computing resources is likewise increasing at a substantial rate. Organizations of all types are finding reasons to analyze more and more data to their respective ends.

Many complimentary technologies have changed the way computing is handled for various users and organizations. For example, improvements in networking performance and availability (e.g., via the Internet) have enabled organizations to rely on cloud-based computing resources rather than building out dedicated, high-performance computing infrastructure to perform data analysis, host enterprise applications, and the like. In particular, organizations have widely embraced cloud computing to accommodate increasing demands for processing data without the need to add more and more physical computing resources on-site. The promise of cloud-based computing resource providers is that such resources are cheaper, more reliable, easily scalable, and potentially best of all—such resources do not require any high-performance on-site computing equipment. Features aside, for many organizations, the decision between purchasing on-site computing resources and paying for “virtual” cloud-based resources boils down to cost. Unfortunately, the myriad promises relating to cloud-based computing have not all come to fruition. In particular, the cost of cloud-based computing resources has turned out in many cases to be as or even more expensive than building dedicated on-site hardware. Moreover, cloud-based customers are subject to the whims of the cloud-based resource providers in terms of cost, availability, features, etc.

Another, perhaps more fundamental, consideration is what about all of the existing, non-dedicated and non-special purpose computing resources in an organization? The exponential increase in computing power in all types of modern computing devices means that an average modern mobile device is more powerful than a desktop workstation of only a few years ago. Thus, as a collective, most organizations have significant amounts of processing resources, which are rarely used anywhere near their processing capacity. What if, then, an organization could leverage all of its existing computing resources without the need for either economically irrational cloud-based services or complicated, purpose-built equipment solutions? Clearly, the organization would significantly benefit from leveraging its non-dedicated and/or non-special purpose computing resources for its computer processing needs in lieu of relying solely on cloud-based services or special-purpose hardware.

One challenge to leveraging non-dedicated and/or non-special, i.e., general purpose computing resources for distributed computing is the interaction between a remote system manager, which may be orchestrating the installation and use of distributed computing tools on the general purpose computing resources, and standard desktop operating systems, which were not built with distributed computing in mind. In particular, the configuration of general purposes computing resources (e.g., an office workstation for an employee) to participate in distributed computing tasks must not prevent the general purpose computing resource from performing its primary role, and the configuration must still comply with organizational policies (e.g., security, network use, access, etc.).

Accordingly, systems and methods are needed to enable efficient deployment of distributed computing tools (e.g., containers, software, applications, etc.) to general purpose computing resources.

### BRIEF SUMMARY

Certain embodiments provide a method for managing deployment of distributed computing resources, including: causing a node agent to be installed on a remote computing node, wherein the node agent is configured to run as an application with user-level privileges on the remote computing node; transmitting, to the node agent using a compact messaging protocol, a request to install a container on the remote computing node, wherein the container is pre-configured with an application; transmitting, to the node agent using the compact messaging protocol, a request to run the application in the container on the remote computing node; and receiving, from the application running on the remote computing node, application data.

Other embodiments provide a non-transitory computer-readable medium comprising instructions to perform the method for managing deployment of distributed computing resources. Further embodiments provide an apparatus configured to perform the method for managing deployment of distributed computing resources.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an embodiment of a heterogeneous distributed computing resource management system.

FIG. 2 depicts an example of a resource pool of a heterogeneous distributed computing resource management system.

FIG. 3 depicts an example of a container of a heterogeneous distributed computing resource management system.

FIG. 4 depicts an example method that may be performed by a heterogeneous distributed computing resource management system.

FIG. 5 depicts an example of using a custom communication protocol between a system manager and a computing resource node within a distributed computing system.

FIG. 6 is a data flow diagram depicting an example of using compact data messages within a distributed computing system.

FIG. 7 depicts an example method for managing deployment of distributed computing resources.

FIG. 8 depicts a processing system 800 that may be used to perform methods described herein.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer readable mediums for managing deployment of distributed computing resources.

Organizations have many types of computing resources that may go underutilized during every day. Many of these computing resources (e.g., desktop and laptop computers) are significantly powerful despite being general-use resources. Thus, a distributed processing system that can unify these disparate computing resources into a high-performance computing environment may provide several benefits, including: a significant decrease in cost of processing organization workloads, and a significant increase in the organization's ability to protect information related to the processing of workloads by processing those workloads on-site in organization-controlled environments. In fact, for some organizations, such as those that deal with sensitive information, on-site processing is the only option because sensitive information may not be allowed to be processed using off-site computing resources, such as cloud-based resources.

Described herein is a cross-platform system of components necessary to unify computing resources in a manner that efficiently processes organizational workloads—without the need for special-purpose on-site computing hardware, or reliance on off-site cloud-computing resources. This unification of computing resources can be referred to as distributed computing, peer computing, high-throughput computing (HTC), or high-performance computing (HPC). Further, because such a cross-platform system may leverage many types of computing resources within a single, organized system, the system may be referred to as a heterogeneous distributed computing resource management system.

One aspect of a heterogeneous distributed computing resource management system is the use of containers across the system of heterogeneous computing resources. A distributed computing system manager may orchestrate containers, applications resident in those containers, and workloads handled by those applications in a manner that delivers maximum performance and value to organizations simultaneously.

There are many advantages of a heterogeneous distributed computing resource management system as compared to the conventional solutions described above. For example, on-site purpose-built hardware rapidly becomes obsolete in performance and capability despite the high-cost of designing, installing, operating, and maintaining such systems. Such systems tend to require homogeneous underlying equipment and tend not to be capable of interacting with other computing resources that are not likewise purpose-built. Further, such systems are not easily upgradeable. Rather, they tend to require extensive and costly overhauls on long intervals meaning that in the time between major overhauls, those systems slowly degrade in their relative performance. By contrast, the heterogeneous distributed computing resource management system described herein can leverage any sort of computing device within an organization through the use of the containers. Because such computing devices are more regularly turned over (e.g., replaced with newer devices), the capability of the system as a whole is continually increasing, but without any special purpose organizational spend. For example, every time a general purpose desktop workstation, laptop, or server is replaced, its improved capabilities are made available to the distributed system.

Another significant advantage is increasing the utilization of existing computing resources. The average general-purpose desktop workstation or laptop is significantly more powerful than what it is regularly used for. In other words, internet browsing, word processing applications, email, etc., do not even come close in most cases to utilizing the full potential of these computing resources. This is true of servers and special purposes machines as well. Servers rarely run at their actual capacity, and special purpose computers (e.g., high-end graphic rendering computers) may only be used for one third or less of a day (e.g., during the workday) at anywhere near their capacity. The ability to utilize the vast number and capability of existing organizational computing resources means that an organization can accomplish much more without having to buy more computing resources, upgrade existing computing resources, etc.

Yet another advantage of a heterogeneous distributed computing resource management system is reducing single points of failure from the system. For example, in a dedicated system or when relying on a cloud-based computing service, an organization is at operational risk of the dedicated system or cloud-based computing service going down. When instead relying on a distributed group of computing resources, the failure of any one, or even several resources, will only have a marginal impact on the distributed system as a whole. That is, a heterogeneous distributed computing resource management system is more fault tolerant than dedicated systems or cloud-based computing services from the organization's perspective.

### Example Heterogeneous Distributed Computing Resource Management System

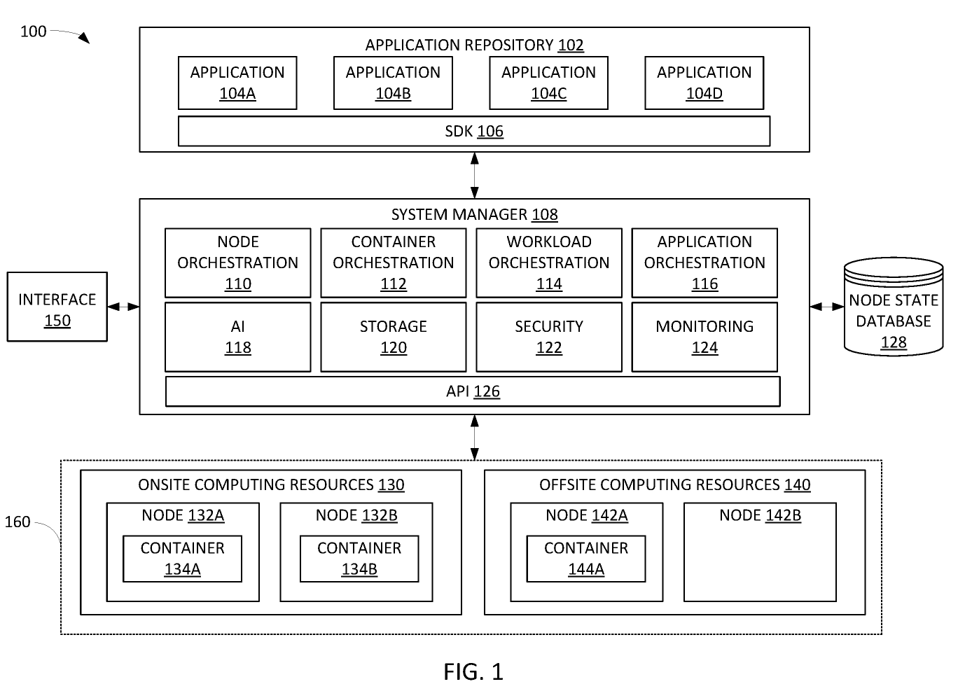

FIG. 1 depicts an embodiment of a heterogeneous distributed computing resource management system 100.

Management system 100 includes an application repository 102. Application repository 102 stores and makes accessible applications, such as applications 104A-D. Applications 104A-D may be used by system 100 in containers deployed on remote resources managed by management system 100, such as containers 134A, 134B, and 144A. In some examples, application repository 102 may act as an application marketplace for developers to market their applications.

Application repository includes a software development kit (SDK) 106, which may include a set of software development tools that allows the creation of applications (such as applications 104A-D) for a certain software package, software framework, hardware platform, computer system, video game console, operating system, or similar development platform. SDK 106 allows software developers to develop applications (such as applications 104A-104D), which may be deployed within management system 100, such as to containers 134A, 134B, and 144A.

Some SDKs are critical for developing a platform-specific application. For example, the development of an Android app on Java platform requires a Java Development Kit, for iOS apps the iOS SDK, for Universal Windows Platform the .NET Framework SDK, and others. There are also SDKs that are installed in apps to provide analytics and data about activity. In some cases, and SDK may implement one or more application programming interfaces (APIs) in the form of on-device libraries to interface to a particular programming language, or to include sophisticated hardware that can communicate with a particular embedded system. Common tools include debugging facilities and other utilities, often presented in an integrated development environment (IDE). Note, though shown as a single SDK 106 in FIG. 1, SDK 106 may include multiple SDKs.

Management system 100 also includes system manager 108. System manager 108 may alternatively be referred to as the “system management core” or just the “core” of management system 100. System manager 108 includes many modules, including a node orchestration module 110, container orchestration module 112, workload orchestration module 114, application orchestration module 116, AI module 118, storage module 120, security module 122, and monitoring module 124. Notably, in other embodiments, system manager 108 may include only a subset of the aforementioned modules, while in yet other embodiments, system manager 108 may include additional modules. In some embodiments, various modules may be combined functionally.

Node orchestration module 110 is configured to manage nodes associated with management system 100. For example, node orchestration module 110 may monitor whether a particular node is online as well as status information associated with each node, such as what the processing capacity of the node is, what the network capacity of the node is, what type of network connection the node has, what the memory capacity of the node is, what the storage capacity of the node is, what the battery power of the node is (if it is a mobile node not running on batter power), etc. Node orchestration module 110 may share status information with artificial intelligence (AI) module 118. Node orchestration module 110 may receive messages from nodes as they come online in order to make them available to management system 100 and may also receive status messages from active nodes in the system.

Node orchestration module 110 may also control the configuration of certain nodes according to predefined node profiles. For example, node orchestration module 110 may assign a node (e.g., 132A, 132B, or 142A) as a processing node, a storage node, a security node, a monitoring node, or other types of nodes.

A processing node may generally be tasked with data processing by management system 100. As such, processing nodes may tend to have high processing capacity and availability. Processing nodes may also tend to have more applications installed in their respective containers compared to other types of nodes.

A storage node may generally be tasked with data storage. As such, storage nodes may tend to have high storage availability.

A security node may be tasked with security related tasks, such as monitoring activity of other nodes, including nodes in common sub-pool of resources, and reporting that activity back to security module 122. A security node may also have certain, security related types of applications, such as virus scanners, intrusion detection software, etc.

A monitoring node may be tasked with monitoring related tasks, such as monitoring activity of other nodes, including nodes in a common sub-pool of resources, and reporting that activity back to monitoring module 124. Such activity may include the nodes availability, the nodes connection quality, and other such data.

Not all nodes need to be a specific type of node. For example, there may be general purpose nodes that include capabilities associated with one or more of processing, storage, security, and monitoring.

Container orchestration module 112 manages the deployment of container to various nodes, such as containers 134A, 134B, and 144A to nodes 132A, 132B, and 142A, respectively. For example, container orchestration module 112 may control the installation of containers in nodes, such as 142B, which are known to management system 100, but which do not yet have containers. In some cases, container orchestration module 112 may interact with node orchestration module 110 to determine the status of various containers on various nodes associated with system 100.

Workload orchestration module 114 is configured to manage workloads distributed to various nodes, such as nodes 132A, 132B, and 142A. For example, when a job is received by management system 100, for example by way of interface 150, workload orchestration module 114 may distribute the job to one or more nodes for processing. In particular, workload orchestration module 114 may receive node status information from node orchestration module 110 and distribute the job to one or more nodes in such a way as to optimize processing time and maximize resources utilization based on the status of the nodes connected to the system.

In some cases, when a node becomes unavailable (e.g., goes offline) or become insufficiently available (e.g., does not have adequate processing capacity), workload orchestration module 114 will reassign the job to one or more other nodes. For example, if workload orchestration module 114 had initially assigned a job to node 132A, but then node 132A went offline, then workload orchestration module 114 may reassign the job to node 132B. In some cases, the reassignment of a job may include the entire job, or just a portion of a job that was not yet completed by the original assigned node.

Workload orchestration module 114 may also provide splitting (or chunking) operations. Splitting or chunking is the act of breaking a large processing job down in to small parts that can be processed by multiple processing nodes at once (i.e., in parallel). Notably, workload orchestration may be handled by system manager 108 as well as by one or more nodes. For example, an instance of workload orchestration module 114 may be loaded onto a node to manage workload within a sub-pool of resources in a peer-to-peer fashion in case access to system manager 108 is not always available.

Workload orchestration module 114 may also include scheduling capabilities. For example, schedules may be configured to manage computing resources (e.g., nodes 132A, 132B, and 142A) according to custom schedules to prevent resource over-utilization, or to otherwise prevent interruption with a nodes primary purpose (e.g., being an employee workstation).

In one example, a node may configured such that it can be used by system 100 only during certain hours of the day. In some cases, multiple levels of resource management may be configured. For example, a first percentage of processing resources at a given node may be allowed during a first time interval (e.g., during working hours) and a second percentage of processing resources may be allowed during a second time interval (e.g., during non-working hours). In this way, the nodes can be configured for maximum resource utilization without negatively affecting end-user experience with the nodes during regular operation (i.e., operation unrelated to system 100). In some cases, schedules may be set through interface 150.

In the example depicted in FIG. 1, workload orchestration module 114 is a part of system manager 108, but in other examples an orchestration module may be resident on a particular node, such as node 132A, to manage the resident node's resources as well as other node's resources in a peer-to-peer management scheme. This may allow, for example, jobs to be managed by a node locally while the node moves in and out of connectivity with system manager 108. In such cases, the node-specific instantiation of a node orchestration module may nevertheless be a “slave” to the master node orchestration module 110.

Application orchestration module 116 manages which applications are installed in which containers, such as containers 134A, 134B, and 144A. For example, workflow orchestration module 114 may assign a job to a node that does not currently have the appropriate application installed to perform the job. In such a case, application orchestration module 116 may cause the application to be installed in the container from, for example, application repository 102.

Application orchestration module 116 is further configured to manage applications once they are installed in containers, such as in containers 134A, 134B, and 144A. For example, application orchestration module 116 may enable or disable applications installed in containers, grant user permissions related to the applications, and grant access to resources. Application orchestration module 116 enables a software developer to, for example, upload new applications, remove applications, manage subscriptions associated with applications, and receive data regarding applications (e.g., number of downloads, installs, active users, etc.) in application repository 102, among other things.

In some examples, application orchestration module 116 may manage the initial installation of applications (such as 104A-104D) in containers on nodes. For example, if a container was installed in node 142B, application orchestration module 116 may direct an initial set of applications to be installed on node 142B. In some cases, the initial set of applications to be installed on a node may be based on a profile associated with the node. In other cases, the initial set of applications may be based on status information associated with the node (such as collected by node orchestration module 110). For example, if a particular node does not regularly have significant unused processing capacity, application orchestration module 116 may determine not to install certain applications that require significant processing capacity.

Like workload orchestration module 114, in some cases application orchestration module 116 may be installed on a particular node to manage deployment of applications in a cluster of nodes. As above, this may reduce reliance on system manager 108 in situations such as intermittent connectivity. And as with the workload orchestration module 114, a node-specific instantiation of an application orchestration module may be a slave to a master application orchestration module 116 running as part of system manager 108.

AI module 118 may be configured to interact with various aspects of management system 100 (e.g., node orchestration module 110, container orchestration module 112, workload orchestration module 114, application orchestration module 116, storage module 120, security module 122, and monitoring module 124) in order to optimize the performance of management system 100. For example, AI module 118 may monitor performance characteristics associated with various nodes and feedback workload optimizations to workload orchestration module 114. Likewise, AI module 118 may monitor network activity between various nodes to determine aberrations in the network activity and to thereafter alert security module 122.

AI module 118 may include a variety of machine-learning models in order to analyze data associated with management system 100 and to optimize its performance. AI module 118 may further include data preprocessing and model training capabilities for creating and maintaining machine learning models.

Storage module 120 may be configured to manage storage nodes associated with management system 100. For example, storage module 120 may monitor status of storage allocations, both long-term and short-term, within management system 100. In some cases, storage module 120 may interact with workload orchestration module 114 in order to distribute data associated with jobs, or portions of jobs to various nodes for short-term or long-term storage. Further, storage module 120 may report such status information to application orchestration module 116 to determine whether certain nodes have enough storage to available for certain applications to be installed on those nodes. Storage information collected by storage module 120 may also be shared with AI module 118 for use in system optimization.

Security module 122 may be configured to monitor management system 100 for any security breaches, such as unauthorized attempts to access containers, unauthorized job assignment, etc. Security module 122 may also manage secure connection generation between various nodes (e.g., 132A, 132B, and 142A) and system manager 108. In some cases, security module 122 may also handle user authentication, e.g., with respect to interface 150. Further, security module 122 may provide connectivity back to enterprise security information and event management (STEM) software through, for example, application programming interface (API) 126.

In some cases, security module 122 may observe secure operating behavior in the environment and make necessary adjustments if a security situation is observed. For example, security module 122 may use machine learning, advanced statistical analysis, and other analytic methods to flag potential security issues within management system 100.

Monitoring module 124 may be configured to monitor the performance of management system 100. For example, monitoring module 124 may monitor and record data regarding the performance of various jobs (e.g., how long the job took, how many nodes were involved, how much network traffic the job created, what percentage processing capacity was used at a particular node, and others. Monitoring 124 may provide the monitoring information to AI module 118 to further enhance system performance.

Monitoring module 124 may also provide the monitoring data to interface 150 in order to display system performance metrics to a user. For example, the monitoring data may be useful to report key performance indicators (KPIs) on a user dashboard.

Application programming interface (API) 126 may be configured to allow any of the aforementioned modules to interact with nodes (e.g., 132A, 132B, and 142A) or containers (e.g., 134A, 134B, or 144A). Further, API 126 may be configured to connect third-party applications and capabilities to management system 100. For example, API 126 may provide a connection to third-party storage systems, such as AMAZON S3®, EGNYTE®, and DROPBOX®, among others.

Management system 100 includes a pool of computing resources 160. The computing resources include on-site computing resources 130, which may include all resources in a particular location (e.g., a building). For example, an organization may have an office with many general purpose computing resources, such as desktop computers, laptop computers, servers, and other types of computing resources as well. Each one of these resources may be a node into which a container and applications may be installed.

Resource pool 160 may also include off-site computing resources 140, such as remote computers, servers, etc. Off-site computing resources 140 may be connected to management system 100 by way of network connections, such as a wide area network connection (e.g., the Internet) or via a cellular data connection (e.g., LTE, 5G, etc.), or by any other data-capable network. Off-site computing resources 140 may also include third-party resources, such as cloud computing resource providers, in some cases. Such third-party services may be able to interact with management system 100 by way of API 126.

Nodes 132A, 132B, and 142A may be any sort of computing resource that is capable of having a container installed on it. For example, nodes 132A, 132B, and 142A may be desktop computers, laptop computers, tablet computers, servers, gaming consoles, or any other sort of computing device. In many cases, nodes 132A, 132B, and 142A will be general purpose computing devices.

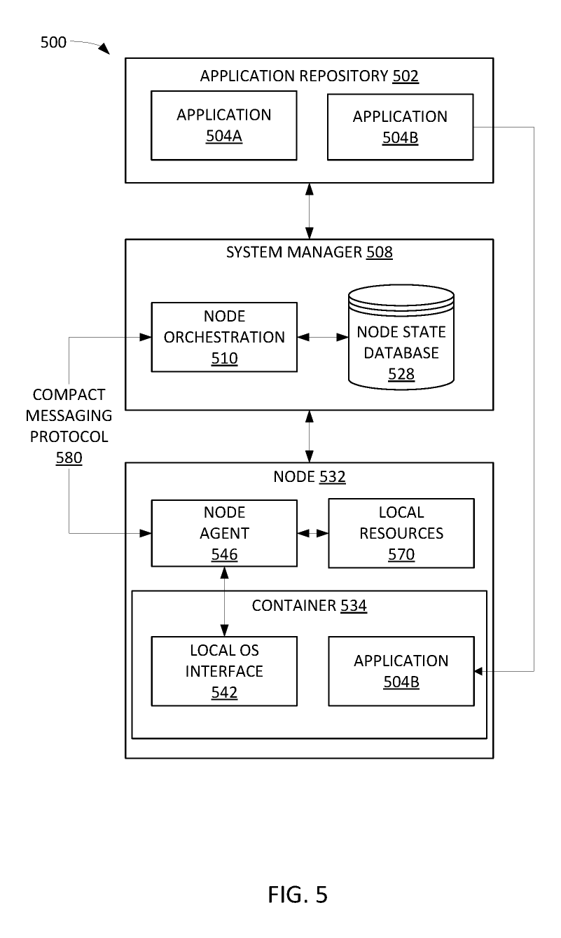

Management system 100 includes node state database 128, which stores information regarding nodes in resource pool 160, including, for example, hardware configurations and software configurations of each node, which may be referred to as static status information. Static status information may include configuration details such as CPU and GPU types, clock speed, memory size, network interface capability, type and version of the operating system, applications installed on node, etc. Node state database 128 may also store dynamic information regarding nodes in resource pool 160, such as the usage state of each node (e.g., power state, network connectivity speed and state, percentage of CPU and/or GPU usage, including usage of specific cores, percentage of memory usage, etc.). In this example node state database 128 is shown separate from system manager 108, but in other embodiments, such as depicted with respect to FIG. 5, below, node state database 128 may be another aspect of system manager 108.

Interface 150 provides a user interface for users to interact with system manager 108. For example, interface 150 may provide a graphical user interface (e.g., a dashboard) for users to schedule jobs, check the status of jobs, check the status of management system 100, configure management system 100, etc.

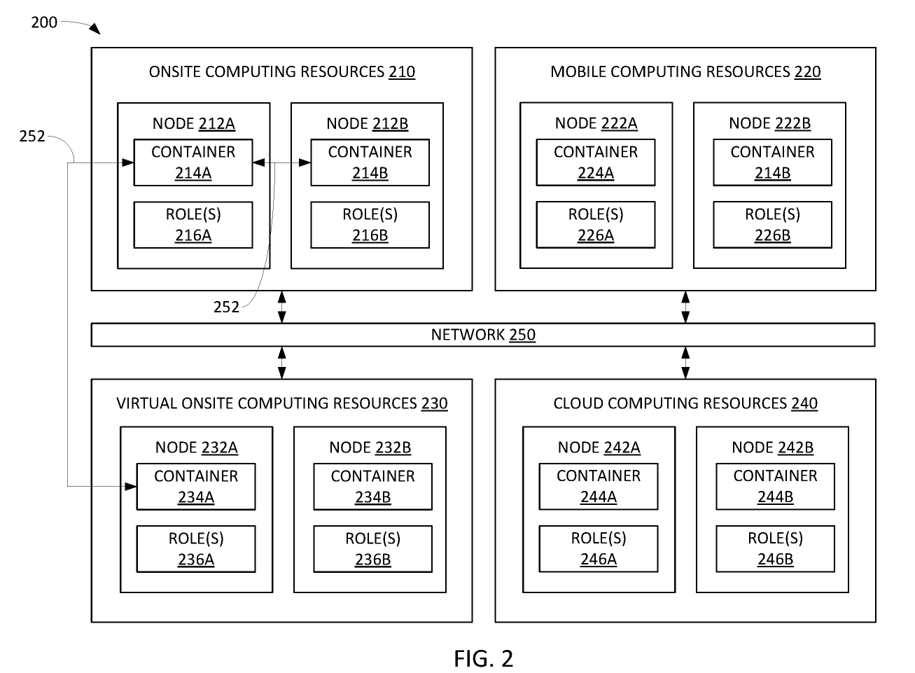

FIG. 2 depicts an example of a resource pool 200 of a heterogeneous distributed computing resource management system, such resource pool 160 in FIG. 1.

Resource pool 200 includes a number of resource sub-pools, such as on-site computing resources 210. As above, on-site resources may be resources at a particular site, such as in a particular building, or within a particular campus, or even on a particular floor. Generally speaking, on-site computing resources are collocated at a physical location and may be connected by a local area network (LAN). On-site computing resources may include any sort of computing resource found regularly in an organization's physical location, such as general purpose desktop and laptop computers, special purpose computers, servers, tablet computers, networking equipment (such as routers, switches, access points), or any other computing device that is capable of having a container installed so that its resources may be utilized to support a distributed computing system.

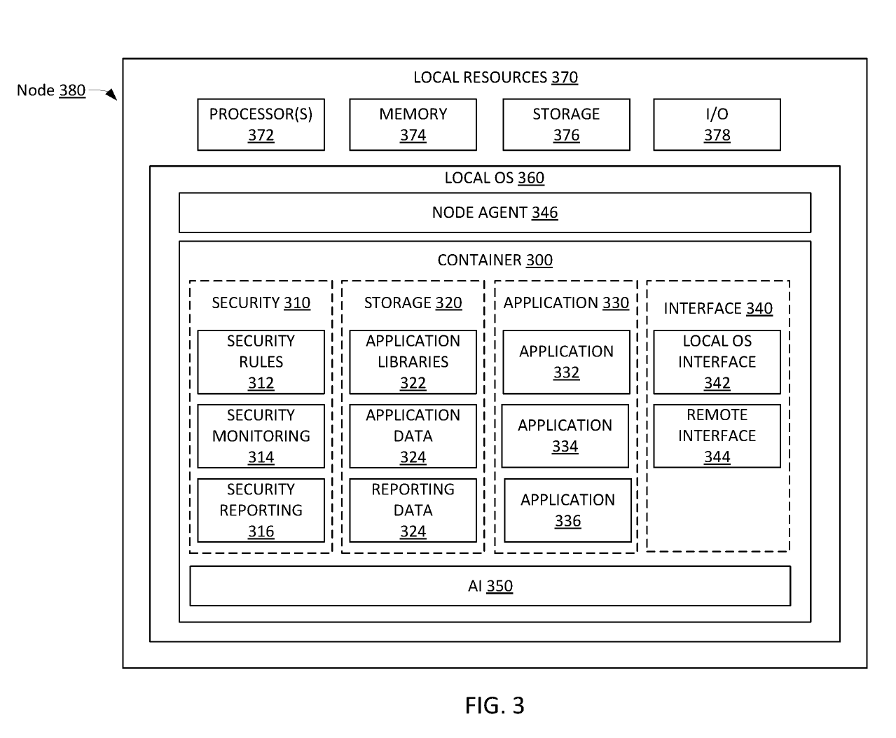

In this example, on-site computing resources 210 include nodes 212A and 212B, which include containers 214A and 214B, respectively. An example of a container will be described in more detail below with respect to FIG. 3.

Nodes 212A and 212B also include roles 216A and 216B, respectively. Roles 216A and 216B may be parameters or configurations provided to nodes 212A and 212B, respectively, during configuration (e.g., such as by node orchestration module 110 in FIG. 1). Roles 216 and 216B may configure the node for certain types of processing for a distributed computing system, such as a processing node role, a storage node role, a security node role, a monitoring node role, and others. In some cases, a node may be configured for a single role, while in other cases a node may be configured for multiple roles.

The roles configured for nodes may also be dynamic based on system needs. For example, a large processing job may call for dynamically shifting the roles of certain nodes to help manage the load of the processing job. In this way the nodes give the management system extensive flexibility to meet any number of use cases dynamically (i.e., without the need for inflexible, static configurations).

As shown with respect to nodes 212A and 212B, nodes may interact with each other (e.g., depicted by arrow 252) in a peer-to-peer fashion in addition to interacting with control elements of the distributed computing management system (e.g., as described with respect to FIG. 1).

On-site computing resources 210 are connected via network 250 to other computing resources, such as mobile computing resources 220, virtual on-site computing resources 230, and cloud computing resources 240. Each of these resource groups includes nodes, containers, and roles, as depicted in FIG. 2.

Mobile computing resources 220 may include devices such as portable computers (e.g., laptop computers and tablet computers), personal electronic devices (e.g., smartphones, smart-wearables), etc., which are not located (at least not permanently), for example, in an organization's office. For example, these types of portable computing resources may be used by users while travelling away from an organization's office.

Virtual on-site computing resources 230 may include, for example, nodes within virtual machines running on other computing resources. Thus, in some cases the network connection between the virtual on-site computing resources 230 and on-site computing resources 210 may be via a virtual network connection maintained by a virtual machine.

Cloud computing resources 240 may include, for example, third party services, such as AMAZON WEB SERVICES®, MICROSOFT AZURE®, and the like. These services may be able to interact with other nodes in the network through appropriate APIs, as discussed above with respect to FIG. 1.

As depicted in FIG. 2, nodes in different resource sub-pools may be configured to interact directly (e.g., in a peer-to-peer fashion), such as shown by line 252. In some cases, for example, a local node (e.g., node 212A) may have as one of its roles a local instance of a workload orchestrator. Thus, node 212A may help direct workloads as discussed above with respect to workload orchestration module 114 in FIG. 1. In other words, here node 212A may act as a local workload orchestrator for node 232A. Similarly, node 212A could have roles as a local node orchestrator, container orchestrator, application orchestrator, and the like.

Though FIG. 2 shows a single network 250 connecting all the types of computing resources, this is merely for convenience. There may be many different networks connecting the various computing resources. For example, mobile computing resources 220 may be connected by a cellular or satellite-based network connection, while cloud computing resources 240 may be connected via a wide area network connection.

FIG. 3 depicts an example of a container 300 as may be used in a heterogeneous distributed computing resource management system, such as system 100 in FIG. 1. Containers offer many advantages, such as isolation, extra security, simplified deployment and, most importantly, the ability to run non-native applications on a machine with a local operating system (e.g., running LINUX® apps on WINDOWS® machines).

As depicted, container 300 is resident within and interacts with a local operating system (OS) 360. In this example, container 300 includes a local OS interface 342, which may be configured based on the type of local OS 360 (e.g., a WINDOWS® interface, a MAC OS® interface, a LINUX® interface, or any other type of operating system). By interfacing with local OS 360, container 300 does not require full virtualization (like a virtual machine) and therefore container 300 may be significantly smaller in size as compared to a virtual machine. The ability for container 300 to be significantly smaller in installed footprint means that container 300 works more readily with a wide variety of computing resources, including those with relatively small storage spaces (e.g., certain types of mobile devices).

Container 300 includes several layers, including (in this example) security layer 310, storage layer 320, application layer 330, and interface layer 340.

Security layer 310 includes security rules 312, which may define local security policies for container 300. For example, security rules 312 may define the types of jobs container 300 is allowed to perform, the types of data container 300 is allowed to interact with, etc. In some cases, security rules 312 may be defined by and received from security module 122 as described with respect to FIG. 1, above. In some cases, the security rules 312 may be defined by an organization's STEM software as part of container 300 being installed on node 380.

Security layer 310 also includes security monitoring module 314, which may be configured to monitor activity related to container 300 as well as node 380. In some cases, security monitoring module 314 may be configured by, or under control of, security module 122 as described with respect to FIG. 1, above. For example, in some cases security monitoring module 314 may be a local instance of security module 122, which is capable of working with or without connection to management system 100, described with respect to FIG. 1, above. This configuration may be particularly useful where certain computing resources are not connected to outside networks for security reasons, such as in the case of secure compartmentalized information facilities (SCIFs).

Security layer 310 also includes security reporting module 316, which may be configured to provide regular, periodic reports of the security state of container 300, as well as event-based specific reports of security issues. For example, security reporting module 316 may report back to security module 122 (in FIG. 1) any condition of container 300, local OS 360, or node 380, which suggests a potential security issue, such as a breach of one of security rules 312.

In some cases, security layer 310 may interact with AI 350. For example, AI 350 may monitor activity patterns and flag potential security issues that would not otherwise be recognized by security rule 312. In this way, security layer 310 may be dynamic rather than static. As discussed above, in some cases AI 350 may be implemented using one or more machine learning models.

Container 300 also includes storage layer 320, which is configured to store data related to container 300. For example, storage layer 320 may include application libraries 322 related to applications installed within container 300 (e.g., applications 330). Storage layer 320 may also include application data 324, which may be produced by operation of applications 330. Storage layer 320 may also include reporting data 324, which may include data regarding the performance and activity of container 300.

Storage layer 320 is flexible in that the amount of storage needed by container 300 may vary based on current job loads and configurations. In this way, container 300's overall size need not be fixed and therefore need not waste space on node 380.

Notably, the components of storage layer 320 depicted in FIG. 3 are just one example, and many other types of data may be stored within storage layer 320.

Container 300 also includes application layer 330, which comprises applications 332, 334, and 336 loaded within container 300. Applications 332, 334, and 336 may perform a wide variety of processing tasks as assigned by, for example, workload orchestration module 114 of FIG. 1. In some cases, applications within application layer 330 may be configured by application orchestration module 116 of FIG. 1.

The number and type of applications loaded into container 300 may be based on one or more roles defined for node 380, as described above with respect to FIG. 2. For example, one role may call for application 332 to be installed, and another role may call for applications 334 and 336 to be installed. As described above, because the roles assigned to a particular node (such as node 380) are dynamic, the number and type of applications installed within container 300 may likewise be dynamic.

Though not depicted in FIG. 3, node 380 may include a run-time system or run-time environment for applications 330 to run within container 300. In some instances, the run-time system or environment may be an off-the-shelf runtime system or environment, such as a Java Runtime Environment, Common Language Runtime, and others, while in other cases the run-time system or environment may be akin to a “miniature” version of an operating system, which includes only necessary standardized libraries.

Container 300 also includes interface layer 340, which is configured to give container 300 access to local resources of node 380 (e.g., by way of local OS interface 342) as well as to interface with a management system, such as management system 100 described above with respect to FIG. 1 (e.g., via remote interface 344).

Local OS interface module 342 enables container 300 to interact with local OS 360, which gives container 300 access to local resources 370. In this example, local resources 370 include processor or processors 372 (or cores within one or more processors 372), memory 374, storage 376, and I/O 378 of node 380. Processors 372 may include general purpose processors (e.g., CPUs) as well as special purpose processors (e.g., GPUs). Local resources 370 also include one or more memories 374 (e.g., volatile and non-volatile memories), one or more storages 376 (e.g., spinning or solid state storage devices), and I/O 378 (e.g., networking interfaces, display outputs, etc.).

Remote interface module 344 provides an interface with a management system, such as management system 100 described above with respect to FIG. 1. For example, container 300 may interact with container orchestration module 112, workload orchestration module 114, application orchestration module 116, and others of management system 100 by way of remote interface 344. As described in more detail below, remote interface module 344 may implement custom protocols for communicating with management system 100.

Container 300 includes a local AI 350. In some examples, AI 350 may be a local instance of AI module 118 described with respect to FIG. 1, while in others AI 350 may be an independent, container-specific AI. In some cases, AI 350 may exist as separate instances within each layer of container 300. For example, there may be an individual AI instance for security layer 310 (e.g., to help identify non-rule based security issues), storage layer 320 (e.g., to help analyze application data), application layer 330 (e.g., to help perform specific job tasks), and/or interface layer 340 (e.g., to interact with a system-wide AI).

A node agent 346 may be installed within local OS 360 (e.g., as an application or OS service) to interact with a management system, such as management system 100 described above with respect to FIG. 1. Examples of local OSes include MICROSOFT WINDOWS®, MAC OS®, LINUX®, and others.

Node agent 346 may be installed by a node orchestration module (such as node orchestration module 110 described with respect to FIG. 1) as part of initially setting up a node to work within a distributed computing system. When installing node agent 346 on certain operating systems, like MICROSOFT WINDOWS®, an existing software tool for remote software delivery, such as MICROSOFT® System Center Configuration Manager (SCCM), may be used to install node agent 346. In some cases, node agent 346 may be the first tool installed on node 380 prior to provisioning container 300.

Generally, node agent 346 is a non-virtualized, native application or service running as a non-elevated (e.g., user-level) resident process on each node. By not requiring elevated permissions, node agent 346 is easier to deploy in managed environments where permissions are tightly controlled. Further, running node agent 346 as a non-elevated user-level protects user experience because it avoids messages or prompts, which require user attention, such as WINDOWS® User Account Control (UAC) pop-ups.

Node agent 346 may function as an intermediary between the management system and container 300. Node agent 346 may be configured to control aspects of container 300, for example, enabling the running of applications (e.g., applications 332, 334, and 336), or even the enabling or disabling of container 300 entirely.

Node agent 346 may provide node status information to the management system, e.g., by querying the local resources 370. The status information may include, for example, CPU and GPU types, clock speed, memory size, type and version of the operating system, etc.

Node agent 346 may also provide container status information, e.g., by querying container 300 via local OS interface 342.

Notably, node agent 346 may not be necessary on all nodes. Rather, node agent 346 may be installed where necessary to interact with operating systems that are not inherently designed to host distributed computing tools, such as container 300, and to participate in heterogeneous distributed computing environments, such as described with respect to FIG. 1.

### Example Method Performed by a Heterogeneous Distributed Computing Resource Management System

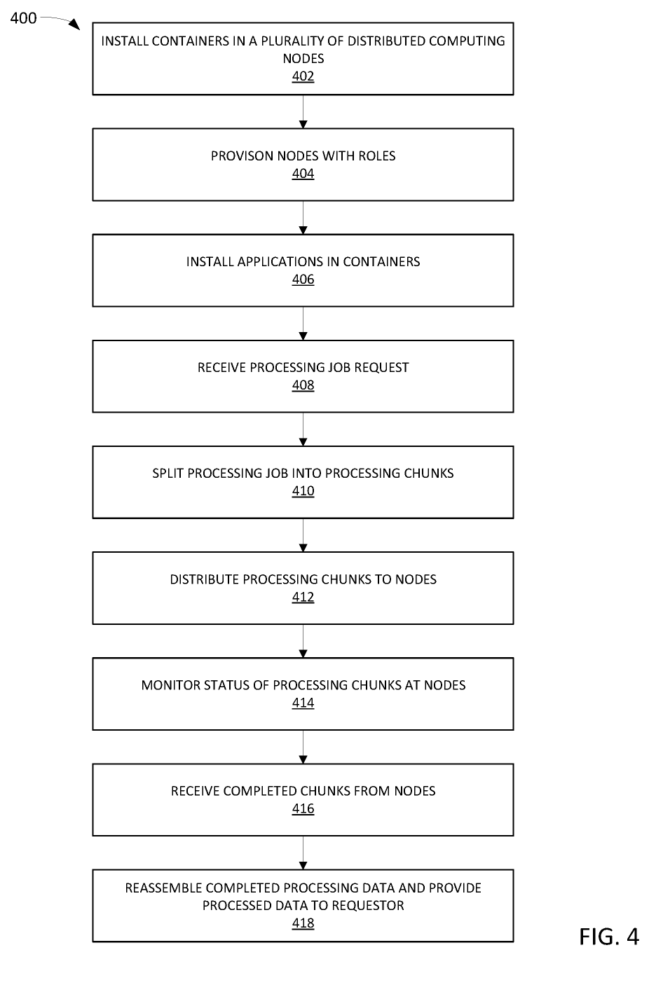

FIG. 4 depicts an example method 400 that may be performed by a heterogeneous distributed computing resource management system, such as system 100 in FIG. 1.

Method 400 begins at step 402 where a plurality of containers, such as container 300 described with respect to FIG. 3, are installed in a plurality of distributed computing nodes. For example, the nodes could be in a resource pool including one or more resource sub-pools, as described with respect to FIG. 2. In some examples, container orchestration module 112 of FIG. 1 may perform the installation of the containers at the plurality of nodes.

The method 400 then proceeds to step 404 where the nodes are provisioned with roles, for example, as described above with respect to FIG. 2. In some cases, nodes may be provisioned with more than one role. In some examples, node orchestration module 110 of FIG. 1 may perform the provisioning of roles to the nodes.

The method 400 then proceeds to step 406 where applications are installed in containers at each of the nodes. In some examples, the applications are pre-installed based on the provisioned roles. In other cases, applications may be installed on-demand based on processing jobs handled by the nodes. For example, applications may be installed and managed by application orchestration module 116, as described above with respect to FIG. 1.

The method 400 then proceeds to step 408, where a processing job request is received. For example, a request may be received from a user of the system via interface 150 of FIG. 1. The job request may be for any sort of processing that may be performed by a distributed computing system. For example, the request may be to transcode a video file from one format to another format.

In some examples, the job request may include parameters associated with the processing job, such as the maximum amount of time acceptable to complete the processing job. Such parameters may be considered by, for example, workload orchestration node 114 of FIG. 1 to determine the appropriate computing resources to allocate to the requested processing job. Another parameter may be associated with the types of computing resources that may be used to complete the job. For example, the request may require that only on-site computing resources can be utilized due to security considerations.

The method 400 then proceeds to step 410 where the processing job is split into chunks. The chunks are portions of the processing job (i.e., sub-jobs, sub-tasks, etc.) that may be handled by different processing nodes so that the processing job may be handled in parallel and thus more quickly. In some examples, the processing job may not be split into chunks if the characteristics of the job do not call for it. For example, if the processing job is extremely small or low priority, it may be kept whole and distributed to a single processing node.

The method 400 then proceeds to step 412 where the chunks are distributed to nodes. In some examples, workload orchestration module 114 of FIG. 1 coordinates the distribution of the chunks. Further, in some examples, AI module 118 of FIG. 1 may work in concert with workload orchestration module 114 in order to distribute the chunks according to a predicted maximum efficiency allocation.

The chunks may be distributed to different nodes in a distributed computing resource system based on many different factors. For example, a node may be chosen for a chunk based on characteristics of the nodes, such as the number or type of processors in the node, or the applications installed at the nodes (e.g., as discussed with respect to FIG. 3), etc. Using the example above of a video transcoding job, it may be preferable to distribute the chunks to nodes that include special purpose processors, such as powerful GPUs, which can process the chunks very efficiently.

A node may also be chosen based on current resource utilizations at the node. For example, if a node is currently heavily utilized by normal activity (such as a personal workstation) or by other processing tasks associated with the distributed computing resource system, it may not be selected for distribution of the chunk.

A node may also be chosen based on scheduled availability of the node. For example, a node that is not scheduled for system availability for several hours may not be chosen while a node that is scheduled for system availability may be preferred. In some cases, where for example the percentage of available processing utilization available at a node is based on schedules, the system may calculate the relative availability of nodes taking into account the schedule constraints.

A node may also be chosen based on network conditions at the node. For example, if a mobile processing node (e.g., a laptop computer) is connected via a relatively lower speed connection (e.g., a cellular connection), it may not be preferred where another node with a faster connection is available. Notably, these are just a few examples of the type of logic that may be used for distributing the chunks to nodes in the distributed computing resource system.

In some examples, one or more of the chunks may be distributed to more than one node such that redundant, parallel processing of various chunks is undertaken. Such a strategy may be based, for example, on an AI prediction that certain nodes may go offline during the processing, or simply to try and maximize the speed of the processing. In other words, where a particular chunk is distributed to more than one node, the first node that finishes the chunk may report the same to the distributed computing resource management system and then the redundant processing may be stopped. In this way, the maximum speed of processing the chunks may be obtained. Thus, using the example above, an individual chunk of a video file to be transcoded may be distributed to multiple processing nodes in an effort to get the best performance where a priori knowledge of the time for processing at each node is not known for sure.

The method 400 then proceeds to step 414 where the status of the processing of the chunks is monitored at the various nodes. For example, monitoring module 124 of FIG. 1 may receive monitoring information from the various nodes as they process the chunks. Information may also be received from workload orchestration module 114 of FIG. 1, which may be managing the processing nodes associated processing job.

In some cases, during step 414 a node may go offline or experience some other sort of performance problem, such as loss of resource availability. In such cases, a chunk may be reassigned to another node in order to maintain the overall progress of the processing job. The monitoring of processing status may also be fed to an AI (e.g., AI module 118 in FIG. 1) in order to train the system as to which nodes are faster, more reliable, etc. Using the feedback from the monitoring, AI module 118 may learn over time to distribute certain types of processing jobs to different nodes, or to distribute chunks in particular manners amongst the available nodes to maximize system performance.

The method 400 then proceeds to step 416 where processed chunks are received from the nodes to which the chunks were originally distributed. For example, workload orchestration module 114 of FIG. 1 may receive the processed chunks.

Though not depicted in FIG. 4, the management system may record performance statistics of each completed processing job. The performance statistics may be used, for example, by an AI (e.g., AI module 118 of FIG. 1) to affect the way a workload orchestration module (e.g., workload orchestration module 114 of FIG. 1) allocates processing jobs or manages processing of jobs.

The method 400 then proceeds to step 418 where the processed chunks are reassembled into a completed processing job and provided to a requestor. Using the example above, the transcoded chunks of the video file may be reassembled into a single, transcoded video file ready for consumption.

In the event any chunks of the original video file were distributed to more than one node for processing, those nodes may be instructed to cease any unfinished processing (e.g., via workload orchestration module 114 of FIG. 1) and to delete the in-progress processing data.

Notably, the steps of method 400 described above are just some examples. In other embodiments, some of the steps may be omitted, additional steps may be added, or the order of the steps may be altered. Method 400 is described for illustrative purposes and is not indicative of the total range of capabilities of, for example, management system 100 of FIG. 1.

### Example Use of Compact Messaging Protocol in Heterogeneous Distributed Computing Resource Management System

FIG. 5 depicts an example of using a custom communication protocol between a system manager and a computing resource node within a distributed computing system 500. Specifically, the custom communication protocol is a compact messaging protocol. Compact messaging protocols are preferably compact, secure, simple, and compatible across many platforms.

Regarding compactness, protocols such as HTTP and HTTPS are verbose, for example, using long text messages to make a request. This verbosity is helpful in a web-centric environment, but is a waste of bandwidth in a context that does not need, for example, human-readable resource identifiers. So a compact messaging protocol may use values or codes (as described further below) rather than verbose messages.

Regarding security, the compact messaging protocol may use, for example, Secure Socket Layer (SSL) or Transport Layer Security (TLS) over Transmission Control Protocol (TCP), which enables, for example, allowing only connections that use appropriate security levels.

Regarding simplicity, a compact messaging protocol that extends well-known and time-tested solutions (such as TLS/TCP) is inherently simpler than other alternatives. Preferably, the compact messaging protocol is both easy to implement and troubleshoot.

Regarding cross-platform compatibility, the availability of cross-platform implementation libraries, such as are available for TLS over TCP, enables the compact messaging protocol to be easily and widely deployed. By contrast, other popular high-level protocols, such as HTTP and its modifications, are well known in the web development context, but not in other contexts. For example, for low-level languages such as C and C++, high-level protocols require use of third-party libraries, which makes them more difficult to implement, and which requires additional layers that users need to use and trust, possibly with very little control or understanding.

Compact messaging protocol 580 may be used, for example, while a distributed computing resource management system delivers software components to a computing resource node, while receiving information about capabilities and current state of the computing resource node, and while controlling the software components installed on the computing resource node, as just a few examples. In this example, compact messaging protocol 580 is used for two-way communication between aspects of system manager 508 (e.g., node orchestration module 510) and computing resource node 532. Notably, in FIG. 5 system manager 508 is depicted with only two aspects (node orchestration module 510 and node state database 528) for simplicity; however, system manager 508 may include any other aspects as described herein, such as with respect to FIG. 1.

The following table depicts example predefined messages for use in compact messaging protocol 580:

TABLE 1
Example Compact Messaging Protocol Values

| Name | Value | Meaning |
|---|---|---|
| Unknown/Error | −1 | Undefined |
| HELLO | 0 | Initial greeting/handshake request from a client |
| ACK | 1 | Acknowledgement: sent by a listener to indicate |
| | | acceptance of a request |
| REQ_DATA | 2 | Client request for a node to report its current state |
| REQ_INSTALL | 3 | Client request for a node to install a container from a |
| | | cloud repository |
| REQ_CUSTOM_INSTALL | 4 | Client request for a node to download and install a |
| | | software package stored on a local server |
| REQ_REMOVE | 5 | Client request for a node to remove a previously installed |
| | | software package |
| REQ_START | 6 | Client request for a node to run a previously installed |
| | | software package (e.g., container or stand-alone |
| | | application) |
| REQ_STOP | 7 | Client request for a node to stop a running package |
| MORE_DATA | 8 | After an acknowledged socket write, client uses this code |
| | | to inform listener that more data is coming |
| NO_MORE_DATA | 9 | After an acknowledged socket write, client informs |
| | | listener that data transfer is complete |
| BYE | 10 | Session will close immediately |

As depicted in TABLE 1, compact messaging protocol 580 includes a plurality of predefined codes (alternatively, values) having respective names and meanings. Within the context of TABLE 1, a “client” may be a system manager (e.g., 508) or an aspect thereof (e.g., node orchestration module 510) and a listener may be a node agent (e.g., 546). Notably, TABLE 1 depicts only a few examples of predefined codes, and many more are possible.

The predefined compact codes may be used, for example, to control the transfer of strings and binary objects between system manager 508 and container 534. For example, compact messaging protocol messages between node orchestration module 510 and node agent 546 may prompt the installation of application 504B from application repository 502 within container 534.

An example session using the messages defined in TABLE 1 may proceed as follows: system manager 508 (client) sends HELLO message→node agent 546 (listener) sends ACK message→system manager 508 sends REQ_INSTALL message followed by secure TCP/TLS write operation on a data chunk→node agent 546 performs a secure TCP/TLS read of the data chunk→node agent 546 sends ACK message→system manager 508 sends MORE_DATA message→node agent 546 reads another data chunk→node agent 546 sends ACK message→system manager 508 sends NO_MORE_DATA message→node agent 546 sends ACK message→system manager 508 sends BYE message→session ends.

As another example, compact messaging protocol messages between node orchestration module 510 and node agent 546 may cause node agent to query the status of local resource 570 and report those back to system manager 508. For example, node orchestration module 510 may receive the status information and store it within node state database 528. As described above with respect to FIG. 1, the status information may include static as well as dynamic status information regarding hardware and software configuration, current use, and historical use, among others. For example, static status information may include information about the hardware and software configuration of the node (e.g., number and type of CPUs, GPUs, amount of memory, type of network connection, etc.). Dynamic status information may include information about how the hardware and software configurations are currently being used (e.g., percentage of CPU usage, percentage of GPU usage, amount of memory used, temperatures, network throughput, etc.). The static and dynamic status information may be used by system manager 508 to manage distributed computing resources, as described above with respect to FIG. 1.

A compact messaging protocol (e.g., 580), which is a non-standard protocol, may be preferable over existing standard messaging protocols (such as HTTP/HTTPS) because of the necessity to protect primary user experience with respect to the computing resource node. In this example, compact message protocol 580 follows a request and response model utilizing compact numeric codes 604 instead of verbose text messages, which are used by other standard web protocols. By using compact codes instead of verbose messaging, network bandwidth utilization is minimized during the orchestration of aspects of container 534. Further, the simplified messaging structure of a compact messaging protocol makes it easier to detect non-expected and malicious behavior (e.g., hacking). While a standard messaging protocol is still usable in this context, it may cause more strain on the resources of node 532, such as more processing cycles and mode network bandwidth. However, compact messaging protocol 580 may be extended to support WebSocket, HTTPS, or other protocols for compatibility with web-applications or other type of services implementing RESTful APIs.

Compact messaging protocol 580 may also be preferable because of the need for security and flexibility. For example, compact messaging protocol 580 may extend the standard SSL/TLS security framework ensuring that all communication is encrypted from the moment of establishing connection between any two endpoints, such as between system manager 508 and node 532. To this end, compact messaging protocol 580 can be configured to allow negotiation to accept the highest TLS version supported by two connected endpoints or, alternatively, require a specific version and reject connection attempts from a peer relying on a less secure TLS version.

Additionally, compact messaging protocol 580 supports redundancy by allowing renegotiation when a command fails and bandwidth throttling when excessive traffic threatens to create network congestion.

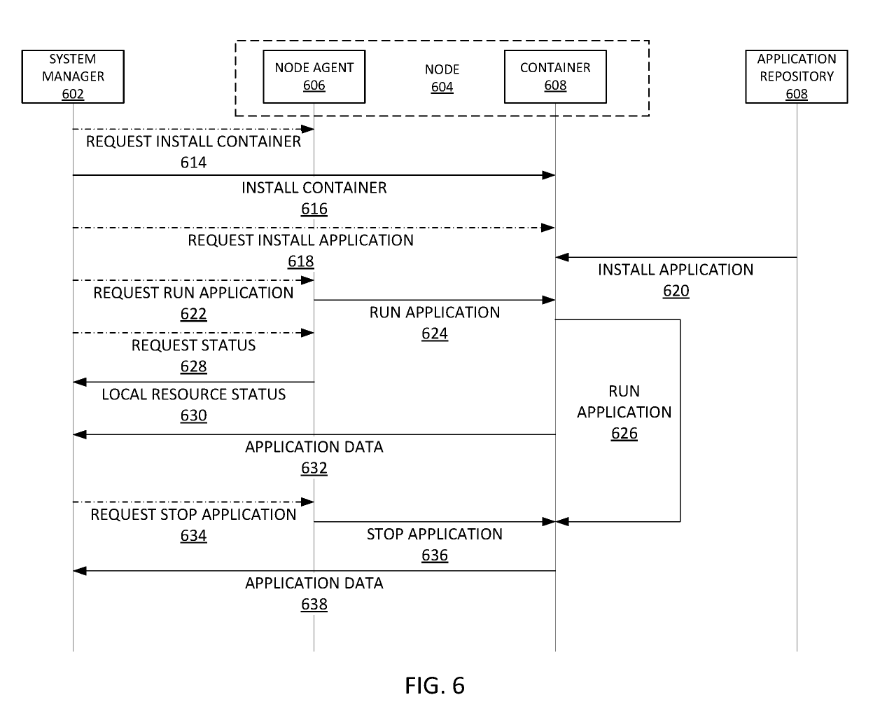

FIG. 6 is a data flow diagram depicting an example of using compact data messages (e.g., defined by a compact messaging protocol, such as described above with respect to FIG. 5) within a distributed computing system. In FIG. 6, each data flow formatted as dash-dot-dash arrow indicates a message transmitted via a compact messaging protocol in this example.

Initially, system manager 602 sends a request 614 to install a container to node agent 606, which is already installed on node 604. In this example, request 614 is sent according to a compact messaging protocol, such as described above with respect to FIG. 5. Further as described above, node agent 606 may be installed by an existing software tool for deployment of software applications to an operating system. In some cases, node agent 606 may be an application running on an operating system, and in other cases node agent 606 may be a background service running within an operating system.

In response to request 614, a container 608 is installed on node 604. The container binaries may be transmitted to node 604 from system manger 602 as indicated by arrow 616. In other examples, the container may be installed from a third-party system hosting, for example, a container repository. For example, a container could be downloaded from a cloud storage system. Further, in some implementations, the container is pre-built or pre-configured with one or more applications that are configured for operation within the container.

Next, system manger 602 transmits a request 618 to install an application within container 608. Request 618 may, for example, relate to an application not already installed within container 608, or an update to an application already installed in container 608. The request 618 may include information regarding the application, such as where the application data files may be downloaded (e.g., from a resource of system manger 602, from a third-party resource, such as a cloud storage provider, from a URL or an IP address, or the like). Request 618 may also include configuration information for the application to make it suitable for use within container 608 on node 604. For example, the configuration information may relate to dynamic or static status information or other configuration information regarding node 604 or container 608.

In response to request 618, an application is installed within container 608 on node 604 for example, as described above with respect to step 406 of FIG. 4. In this example, the application data files are transmitted from an application repository as depicted by arrow 620. However, the application data files may be provided from any location accessible by node 604.

Notably, steps 618 and 620 may not be necessary in cases where the container installed in step 616 is already configured with the necessary application.

Next, system manager 602 transmits a request 622 to node agent 606 to run the application now installed within container 608 on node 604. Here again, request 622 is sent according to a compact messaging protocol.

Node agent 606 then instructs (as shown by arrow 624) the application within container 608 to run, e.g., via container 608's local OS interface (not shown). Since node agent 606 is running within the local OS, the local OS interface provides one method for node agent 606 and container 608 to exchange data, including instructions received from system manager 602.

The application installed within container 608 on node 604 then begins to run, as indicated by arrow 626.

Next, system manager 602 transmits a status request 628 to node agent 606. Here again, request 628 is sent according to a compact messaging protocol.

In response, node agent 606 provides local resource status to system manager 602, as indicated by arrow 630. For example, the local resource status may be monitored by system manger 602 to ensure that the application running (arrow 626) does not overtax node 604.

The application running within container 608 also provides application data to system manager 602, as indicated by arrow 632. For example, the application data could be related to a distributed data analysis operation being conducted with node 604 among other nodes.

Next, system manger 602 transmits a request 634 to stop running the application within container 608 on node 604. Here again, request 634 is sent according to a compact messaging protocol. In response, node agent 606 transmits instructions 636 to the application running in container 608 to stop the application.

Next, the application running within container 608 provides any remaining application data to system manager 602, as indicated by arrow 638.

Notably, FIG. 6 is just one example of message and data flows between aspects of a distributed computing system. Not all messages and data flows are shown and not all aspects of the distributed computing system are depicted for simplicity. Many other examples are possible.

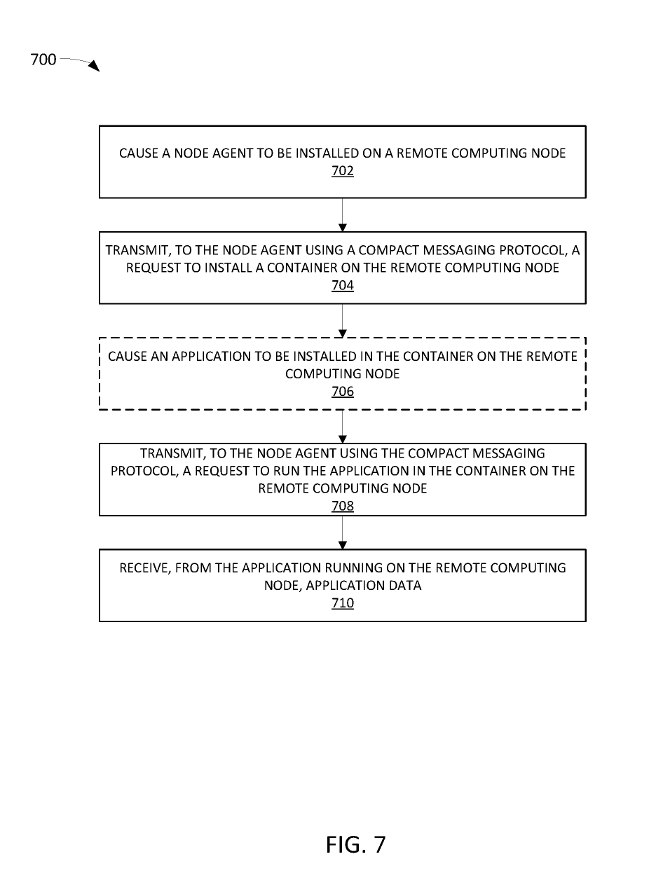

FIG. 7 depicts an example method 700 for managing deployment of distributed computing resources.

Method 700 begins at step 702 with causing a node agent to be installed on a remote computing node. In some instances, the node agent is configured to run as an application with user-level or otherwise standard, non-escalated privileges on the remote computing node. For example, a node orchestration module such as described with respect to FIGS. 1 and 5 may cause the node agent to be installed on the remote computing node.

Method 700 then proceeds to step 704 with transmitting, to the node agent using a compact messaging protocol, a request to install a container on the remote computing node. In some implementations, the container may be pre-built or pre-configured with one or more applications that are configured for operation within the container.

In some implementations, the compact messaging protocol comprises a plurality of predefined messages associated with respective predefined codes, as discussed above with respect to FIG. 5. Further, in some embodiments, the compact messaging protocol implements TLS or SSL over TCP. Notably, other inherently secure protocols make likewise be used over other transport protocols. Further, a container orchestration module such as described with respect to FIG. 1 may coordinate the installation of the container on the remote computing node.

Method 700 may then proceed to optional step 706 with causing an application to be installed in the container on the remote computing node, for example, as described above with respect to step 406 of FIG. 4. Step 706 may be necessary where the container installed in step 704 either did not include any pre-configured applications, or where the container did not include the necessary application. In some implementations, applications files (e.g., binaries) may be downloaded by the remote computing node from an application repository, such as described with respect to FIG. 1. Further, an application orchestration module such as described with respect to FIG. 1 may coordinate the installation of the application on the remote computing node.

In some implementations, the request to install the application includes information for where to find the application (e.g., a link, URL, IP address, cloud platform (e.g. GOOGLE CLOUD®) or others). Further, the request to install the application may also include credentials or other authorization and authentication data necessary to access the application repository. Further yet, the request to install the application may also include application access data (e.g., license numbers or files) necessary to install the application on the remote computing node. Notably, this additional information may be included as encoded compact messages, or as supplemental verbose messages after the compact request to install. In yet further implementations, the remote computing node may request such information prior to receiving them, and request a form of transmission, such as compact or verbose.

Method 700 then proceeds to step 708 with transmitting, to the node agent using the compact messaging protocol, a request to run the application in the container on the remote computing node. For example, a workload orchestration module such as described with respect to FIG. 1 may coordinate the running of the application on the remote computing node to process data in a distributed fashion.

In some implementations, the request to run the application may include parameters for running the application. Further, in some implementations, the request to run the application includes data or a location for where to find the application (e.g., a link, URL, IP address, or others). As above, this additional information may be included as encoded compact messages, or as supplemental verbose messages after the compact request to install. In yet further implementations, the remote computing node may request such information prior to receiving them, and request a form of transmission, such as compact or verbose.

Method 700 then proceeds to step 710 with receiving, from the application running on the remote computing node, application data. The application data may be, for example, the results of an analysis performed by the application. In some cases, the application data may be a portion or chunk of an analysis coordinated across many remote computing nodes by a distributed computing resource management system, as described above with respect to FIGS. 1 and 4. For example, a workload orchestration module such as described with respect to FIG. 1 may coordinate the receipt, reassembly, and other processes related to the application data received from the remote computing node.

Though not depicted in FIG. 7, method 700 may further include receiving, from the node agent, dynamic status information regarding the remote computing node, such as described above with respect to FIG. 5. Method 700 may further include transmitting, to the node agent using the compact messaging protocol, a request to stop the application based on the dynamic status information.

Method 700 may further include receiving, from the node agent, static status information regarding the remote computing node, such as described above with respect to FIG. 5, and determining the container to install on the remote computing node based on the static status information (e.g., where a plurality of pre-configured containers are available for installation on the remote computing node). For example, the static status information may include a type of CPU installed on the remote computing node and a type of GPU installed on the remote computing node.

Notably, method 700 is just one example, and different steps may be included or excluded consistent with the description herein.

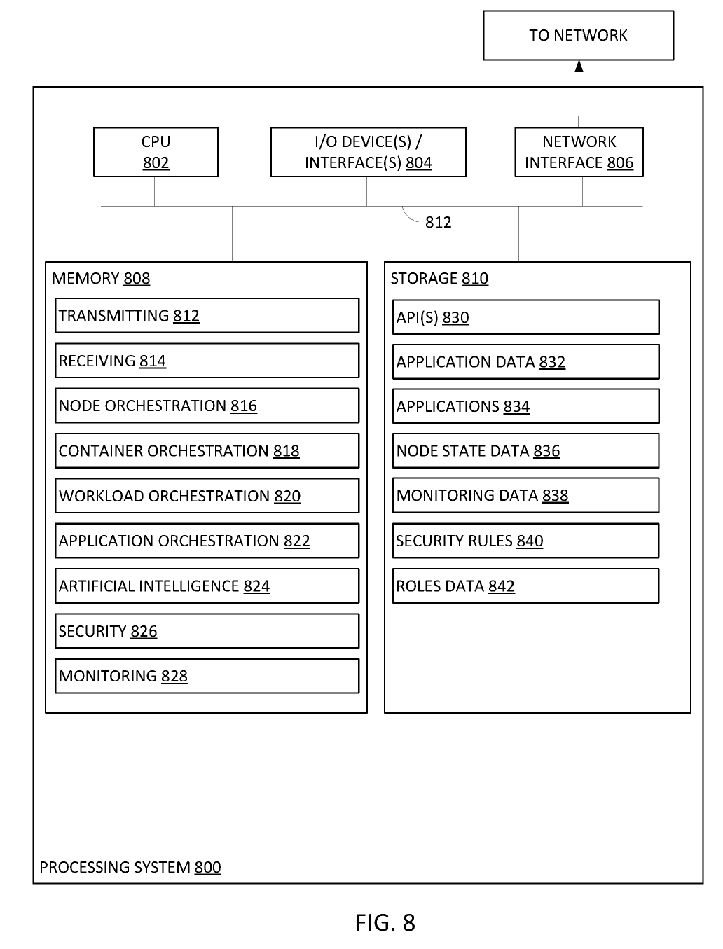

FIG. 8 depicts a processing system 800 that may be used to perform methods described herein, such as the method for managing distributed computing resource described above with respect to FIG. 4 and the method for managing deployment of distributed computing resources described above with respect to FIG. 7.

Processing system 800 includes a CPU 802 connected to a data bus 812. CPU 802 is configured to process computer-executable instructions, e.g., stored in memory 808 or storage 810, and to cause processing system 800 to perform methods as described herein, for example with respect to FIGS. 4 and 7. CPU 802 is included to be representative of a single CPU, multiple CPUs, a single CPU having multiple processing cores, and other forms of processing architecture capable of executing computer-executable instructions.

Processing system 800 further includes input/output device(s) and interface(s) 804, which allows processing system 800 to interface with input/output devices, such as, for example, keyboards, displays, mouse devices, pen input, and other devices that allow for interaction with processing system 800. Note that while not depicted with independent external I/O devices, processing system 800 may connect with external I/O devices through physical and wireless connections (e.g., an external display device).

Processing system 800 further includes network interface 806, which provides processing system 800 with access to external networks and thereby external computing devices.

Processing system 800 further includes memory 808, which in this example includes transmitting component 812 and receiving component 814, which may perform transmitting and receiving functions as described above with respect to FIGS. 1-7.

Memory 808 further includes node orchestration component 816, which may perform node orchestrations functions as described above with respect to FIGS. 1-7.

Memory 808 further includes container orchestration component 818, which may perform container orchestrations functions as described above with respect to FIGS. 1-7.

Memory 808 further includes workload orchestration component 820, which may perform workload orchestrations functions as described above with respect to FIGS. 1-7.

Memory 808 further includes node application component 822, which may perform application orchestrations functions as described above with respect to FIGS. 1-7.

Memory 808 further includes node artificial intelligence (AI) 824, which may perform AI functions as described above with respect to FIGS. 1-7.

Memory 808 further includes security component 826, which may perform security functions as described above with respect to FIGS. 1-7.

Memory 808 further monitoring component 828, which may perform monitoring functions as described above with respect to FIGS. 1-7.

Note that while shown as a single memory 808 in FIG. 8 for simplicity, the various aspects stored in memory 808 may be stored in different physical memories, but all accessible CPU 802 via internal data connections, such as bus 812, or external data connections, such as network interface 806 or I/O device interfaces 804.

Processing system 800 further includes storage 810, which in this example includes application programming interface (API) data 830, such as described above with respect to FIGS. 1-7.

Storage 810 further includes application data 832, such as described above with respect to FIGS. 1-7.

Storage 810 further includes applications 834 (e.g., installation files, binaries, libraries, etc.), such as described above with respect to FIGS. 1-7.

Storage 810 further includes node state data 836, such as described above with respect to FIGS. 1-7.

Storage 810 further includes monitoring data 838, such as described above with respect to FIGS. 1-7.

Storage 810 further includes security rules 840, such as described above with respect to FIGS. 1-7.

Storage 810 further includes roles data 842, such as described above with respect to FIGS. 1-7.

While not depicted in FIG. 8, other aspects may be included in storage 810.

As with memory 808, a single storage 810 is depicted in FIG. 8 for simplicity, but the various aspects stored in storage 810 may be stored in different physical storages, but all accessible to CPU 802 via internal data connections, such as bus 812, I/O interfaces 804, or external connection, such as network interface 806.

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for managing deployment of distributed computing resources, comprising:
causing a node agent to be installed on a remote computing node, wherein the node agent is configured to run as an application with user-level privileges on the remote computing node;
transmitting, to the node agent using a compact messaging protocol, a request to install a container on the remote computing node, wherein the container is pre-configured with an application;
transmitting, to the node agent using the compact messaging protocol, a request to run the application in the container on the remote computing node; and
receiving, from the application running on the remote computing node, application data.

2. The method of claim 1, further comprising: receiving, from the node agent, dynamic status information regarding the remote computing node.

3. The method of claim 2, further comprising: transmitting, to the node agent using the compact messaging protocol, a request to stop the application based on the dynamic status information.

4. The method of claim 1, further comprising: receiving, from the node agent, static status information regarding the remote computing node.

5. The method of claim 4, further comprising: determining the container to install on the remote computing node based on the static status information.

6. The method of claim 5, wherein the static status information comprises:
a type of CPU installed on the remote computing node; and
a type of GPU installed on the remote computing node.

7. The method of claim 1, wherein:
the compact messaging protocol comprises a plurality of predefined messages associated with respective predefined codes, and
the compact messaging protocol implements TLS over TCP.

8. A non-transitory computer-readable medium comprising instructions for performing a method for managing deployment of distributed computing resources, the method comprising:
causing a node agent to be installed on a remote computing node, wherein the node agent is configured to run as an application with user-level privileges on the remote computing node;
transmitting, to the node agent using a compact messaging protocol, a request to install a container on the remote computing node, wherein the container is pre-configured with an application;
transmitting, to the node agent using the compact messaging protocol, a request to run the application in the container on the remote computing node; and
receiving, from the application running on the remote computing node, application data.

9. The non-transitory computer-readable medium of claim 8, further comprising: receiving, from the node agent, dynamic status information regarding the remote computing node.

10. The non-transitory computer-readable medium of claim 9, further comprising: transmitting, to the node agent using the compact messaging protocol, a request to stop the application based on the dynamic status information.

11. The non-transitory computer-readable medium of claim 8, further comprising: receiving, from the node agent, static status information regarding the remote computing node.

12. The non-transitory computer-readable medium of claim 11, further comprising: determining the container to install on the remote computing node based on the static status information.

13. The non-transitory computer-readable medium of claim 12, wherein the static status information comprises:
a type of CPU installed on the remote computing node; and
a type of GPU installed on the remote computing node.

14. The non-transitory computer-readable medium of claim 8, wherein:
the compact messaging protocol comprises a plurality of predefined messages associated with respective predefined codes, and
the compact messaging protocol implements TLS over TCP.

15. An apparatus for managing deployment of distributed computing resources, comprising:
a memory comprising computer-executable instructions;
a processor in data communication with the memory and configured to execute the computer-executable instructions and cause the apparatus to perform a method for managing deployment of distributed computing resources, the method comprising:
causing a node agent to be installed on a remote computing node, wherein the node agent is configured to run as an application with user-level privileges on the remote computing node;
transmitting, to the node agent using a compact messaging protocol, a request to install a container on the remote computing node, wherein the container is pre-configured with an application;
transmitting, to the node agent using the compact messaging protocol, a request to run the application in the container on the remote computing node; and
receiving, from the application running on the remote computing node, application data.

16. The apparatus of claim 15, wherein the method further comprises: receiving, from the node agent, dynamic status information regarding the remote computing node.

17. The apparatus of claim 16, wherein the method further comprises: transmitting, to the node agent using the compact messaging protocol, a request to stop the application based on the dynamic status information.

18. The apparatus of claim 15, wherein the method further comprises:
receiving, from the node agent, static status information regarding the remote computing node; and
determining the container to install on the remote computing node based on the static status information.

19. The apparatus of claim 18, wherein the static status information comprises:
a type of CPU installed on the remote computing node; and
a type of GPU installed on the remote computing node.

20. The apparatus of claim 15, wherein:
the compact messaging protocol comprises a plurality of predefined messages associated with respective predefined codes, and
the compact messaging protocol implements TLS over TCP.
